(19) United States
(12) Patent Application Publication
(10) Pub. No.: US 2013/0034748 A1
(43) Pub. Date: Feb. 7, 2013

(54) MAGNETIC RECORDING MEDIUM AND PRODUCTION METHOD OF MAGNETIC RECORDING MEDIUM

(71) Applicants: Shunji Ishio, Akita (JP); Shun Shibata, Akita (JP)

(72) Inventors: Shunji Ishio, Akita (JP); Shun Shibata, Akita (JP)

(73) Assignee: AKITA UNIVERSITY, Akita (JP)

(21) Appl. No.: 13/641,930

(22) PCT Filed: Apr. 21, 2011
(86) PCT No.: PCT/JP2011/059856

§ 371 Date: Oct. 18, 2012

(30) Foreign Application Priority Data
Apr. 23, 2010 (JP) 2010-100297

(51) Int. Cl. G11B 5/65; G11B 5/84

(52) U.S. Cl. 428/836.2; 148/537

(57) ABSTRACT

The present invention provides: a method of producing, at low temperature, a magnetic recording medium comprising an L1₀FePt thin film which is highly (001)-oriented and highly L1₀-ordered; and a magnetic recording medium comprising an L1₀FePt thin film that can be obtained by this method. In the production method of a magnetic recording medium (10), a thin film formation step S1 of forming a thin film 2 containing an FePt alloy and an oxide of metal having a melting point of 100° C. or more and 500° C. or less is carried out; an annealing step S2 of annealing the thin film 2 to a predetermined temperature is carried out; thereby a magnetic recording layer 2′ containing the FePt alloy having a L1₀-ordered structure and the oxide of metal is formed. The magnetic recording medium can be obtained by this production method.

### TECHNICAL FIELD

The present invention relates to a magnetic recording medium and a production method of a magnetic recording medium.

### BACKGROUND ART

Recently, there has been a desire to increase the areal recording density of a magnetic recording medium such as a hard disk to increase the storage capacity thereof, and studies have been carried out to realize this. In order to enhance the areal recording density of the magnetic recording medium, it is necessary to refine the recording bit. However, refining the recording bit causes a problem so-called “thermal fluctuation” that the magnetization direction of the magnetic recording layer is changed due to thermal energy, leading to data loss.

The “perpendicular magnetic recording” has been put to practical use as a technique that can inhibit the influence of the thermal fluctuation. The perpendicular magnetic recording is a method in which the magnetization direction of the recording bit is made perpendicular to the magnetic recording layer. In the perpendicular magnetic recording, the diamagnetic fields of the adjacent recording bits act on each other so as to reinforce each other. Therefore, as for the recording bit in the perpendicular magnetic recording, even if the size thereof in a direction parallel to the magnetic recording layer is reduced, it is possible to inhibit the influence of the thermal fluctuation by increasing the size of the recording bit in the perpendicular direction to increase its volume.

Nonetheless, even when the perpendicular magnetic recording is adopted, it is still necessary to refine the recording bit in order to realize a high areal recording density. Therefore, trying to realize a higher magnetic recording density causes the problem of the thermal fluctuation even with the perpendicular magnetic recording method. To solve this problem, there have been considerations on using in a magnetic recording layer, a material with a perpendicular magnetic anisotropy much higher than that of CoCr alloy that has been conventionally employed.

As an example of the material with a perpendicular magnetic anisotropy higher than that of CoCr alloy, FePt alloy having an L1₀-ordered structure (hereinafter sometimes simply referred to as “L1₀FePt alloy”.) has been studied. The “L1₀-ordered structure” is a structure in which two kinds of atoms are alternately stacked in a fcc structure, with the composition ratio of the two kinds of atoms at 1:1. FIG. 6 shows a schematic view of the L1₀-ordered structure, taking L1₀FePt alloy as an example. When Fe and Pt are randomly arranged, the alloy thereof becomes a disordered alloy with a fcc structure.

The L1₀FePt alloy is expected as a magnetic recording medium with an ultra-high density of 10 Tbit/inch². Further, as it has excellent corrosion resistance and oxidation resistance, the L1₀FePt alloy is expected as a material that can be suitably applied to a magnetic recording medium. in order to put the L1₀FePt alloy to practical use as a magnetic recording medium, it is necessary to form a thin film containing L1₀FePt alloy which is highly (001)-oriented and highly L1₀-ordered, in a thickness of several nanometers, on a substrate made of metal or glass (hereinafter, the thin film containing L1₀FePt alloy may be simply referred to as an “L1₀FePt thin film”.). Furthermore, in a practical viewpoint, it is desirable to form an L1₀FePt thin film for example on a polycrystalline surface such as amorphous thermal silicon oxide (SiO₂) at a temperature as low as possible, without necessitating a special crystal face or a surface treatment on the substrate made of metal or glass.

The following methods have been reported heretofore as the methods for forming an L1₀FePt thin film on a polycrystalline substrate:

(1) adding metal (Sb, Ag, Cu) or an oxide (MgO, SiO₂, B₂O₃, ZrO₂) when forming a film (e.g. Non-Patent Documents 1 and 2; Patent Document 1);

(2) carrying out a rapid thermal annealing after forming a film (e.g. Non-Patent Documents 3 and 4); and

(3) adding metal (Sb, Ag, Cu) or an oxide (MgO, SiO₂, B₂O₃, ZrO₂) when forming a film, and carrying out a rapid thermal annealing after forming a film (e.g. Non-Patent Documents 5 to 7).

### CITATION LIST

### Patent Literature

Patent Document 1: Japanese Patent Application Laid-Open (JP-A) No. 2006-202451

### Non-Patent Literature

Non-Patent Document 1: Tomoyuki Maeda at al. “Reduction of ordering temperature of an FePt-ordered alloy by addition of CU”, Applied Physics Letter, US, American Institute of Physics, Mar. 25, 2002, Vol. 80, No. 12, p. 2147.
Non-Patent Document 2: Qingyu Yan et al. “Enhanced Chemical Ordering and Coercivity in FePt Alloy Nanoparticles by Sb-Doping”, Advanced Materials, Germany, WILEY-VCH Verlag GmbH & Co. KGaA, Aug. 8, 2005, Vol. 17, No. 18, p. 2233-2237.
Non-Patent Document 3: Yuji Itoh at al. “Structural and Magnetization Properties of Island FePt Produced by Rapid Thermal Annealing”, Japanese Journal of Applied Physics, Japan, The Japan Society of Applied Physics, Dec. 9, 2004, Vol. 43, p. 8040-8043.
Non-Patent Document 4: Yuji Itoh et al. “Magnetic and Structural Properties of FePt Thin Film Prepared by Rapid Thermal Annealing”, Japanese Journal of Applied Physics, Japan, The Japan Society of Applied Physics, Aug. 13, 2002, Vol. 41, p. 141066-L1068.
Non-Patent Document 5: C. L. Platt et al. “L1₀ ordering and microstructure of FePt thin films with Cu, Ag, and Au additive”, Journal of Applied Physics, US, American Institute of Physics, Nov. 15, 2002, Vol. 92, No. 10, p. 6104.
Non-Patent Document 6: M. L. Yan et al. “L1₀, (001)-oriented FePt:B₂O₃ composite films for perpendicular recording”, Journal of Applied Physics, US, American Institute of Physics, May 15, 2002, Vol. 91, No. 101, p. 8471.
Non-Patent Document 7: C. Luo et al. “Structural and magnetic properties of FePt:SiO₂ granular thin films”, Applied Physics Letter, US, American Institute of Physics, Nov. 15, 1999, Vol. 75, No. 20, p. 3162.

### SUMMARY OF THE INVENTION

### Problems to be Solved by the Invention

As described above, conventionally, in forming an L1₁₀FePt thin film, metal is added for the purpose of substitution with Fe; or an oxide of a light element such as Si, B, Mg is added for the purpose of accelerating diffusion of the element. Using these additives helps produce a positive effect to some extent. However, in the conventional formation methods, it is difficult to make a highly (001)-oriented and highly L1₀-ordered L1₀FePt thin film at low temperature.

Accordingly, an object of the present invention is to provide: a method of producing, at low temperature, a magnetic recording medium comprising an L1₀FePt thin film which is highly (001)-oriented and highly L1₀-ordered; and a magnetic recording medium comprising an L1₀FePt thin film that can be obtained by this method.

### Means for Solving the Problems

The inventors have found that an L1₀FePt thin film which is highly (001)-oriented and highly L1₀-ordered can be obtained by adding a specific oxide to an FePt alloy and carrying out rapid annealing thereof; and have completed the present invention described below.

A first aspect of the present invention is a magnetic recording medium comprising a magnetic recording layer which contains an FePt alloy having an L1₀-ordered structure and an oxide of metal having a melting point of 100° C. or more and 500° C. or less. In the present invention of the first aspect and the present invention described below (hereinafter, simply referred to as the “present invention”), the “oxide of metal having a melting point of 100° C. or more and 500° C. or less” means that the melting point of the metal to form the metal oxide is 100° C. or more and 500° C. or less. It does not mean that the melting point of the metal oxide is 100° C. or more and 500° C. or less.

In the magnetic recording medium of the first aspect of the present invention, an oxide formation free energy ΔG_{f}° at room temperature, of the metal having a melting point of 100° C. or more and 500° C. or less is −800 kJ/mol or more and −500 kJ/mol or less. It should be noted that in the present invention, the “oxide formation free energy ΔG_{f}° at room temperature” is obtained by using an oxide formation free energy ΔG_{f}° at room temperature which is described in “Title: Thermochemical Data of Pure Substance; Author: Ihsan Barin; Published by VCH in 1989”, and converting it into an oxide formation free energy ΔG_{f}° per O₂ molecule.

Further, in the magnetic recording medium of the first aspect of the present invention, the oxide of metal having a melting point of 100° C. or more and 500° C. or less is preferably ZnO.

Furthermore, in the magnetic recording medium of the first aspect of the present invention, in the case of containing ZnO in the magnetic recording layer, ZnO is preferably contained in the magnetic recording layer in an amount of 2.5 volume % or more and 20 volume % or less with respect to the total amount of the FePt alloy and ZnO.

A second aspect of the present invention is a production method of a magnetic recording medium wherein a thin film formation step of forming a thin film containing an FePt alloy and an oxide of metal having a melting point of 100° C. or more and 500° C. or less is carried out, and an annealing step of annealing the thin film to a predetermined temperature is carried out, to form a magnetic recording layer containing the FePt alloy having a L1₀-ordered structure and the oxide of the metal.

In the production method of a magnetic recording medium of the second aspect of the present invention, an oxide formation free energy ΔG_{f}° at room temperature, of the metal having a melting point of 100° C. or more and 500° C. or less is −800 kJ/mol or more and −500 kJ/mol or less.

Further, in the production method of a magnetic recording medium of the second aspect of the present invention, the oxide of metal having a melting point of 100° C. or more and 500° C. or less is preferably ZnO.

Furthermore, in the production method of a magnetic recording medium of the second aspect of the present invention, in the case of containing ZnO in the magnetic recording layer, ZnO is preferably contained in the magnetic recording layer in an amount of 2.5 volume % or more and 20 volume % or less with respect to the total of the FePt alloy and ZnO.

Moreover, in the production method of a magnetic recording medium of the second aspect of the present invention, the annealing step is preferably a step of annealing the thin film to a predetermined temperature at an annealing rate of 30° C. or more per second.

Additionally, in the production method of a magnetic recording medium of the second aspect of the present invention, the annealing step is preferably a step of annealing the thin film to a temperature of 400° C. or more and 500° C. or less.

### Effects of the Invention

The magnetic recording medium of the first aspect of the present invention can be a magnetic recording medium comprising an L1₀FePt thin film which is highly (001)-oriented and highly L1₀-ordered, within a short time in a low-temperature process by containing, in the magnetic recording medium, an oxide of metal having a melting point of 100° C. or more and 500° C. or less. Further, a polycrystalline material such as glass can be used as a substrate; and accordingly, an ordinarily employed aluminum substrate or glass substrate can be used. Therefore, it is not necessary to carry out a high-temperature process such as epitaxial growth or a special step of forming a film such as a buffer layer. Furthermore, in adding ZnO etc., it can be used as a target to form a film by sputtering. Therefore, the magnetic recording medium of the first aspect of the present invention is easy to produce and economically efficient. Additionally, since an L1₀FePt thin film which is highly (001)-oriented and highly L1₀-ordered can be obtained by rapid annealing for a short time, it can be easily put to use and is economically highly efficient. In a case of the shortest annealing time, it is possible to obtain an L1₀FePt thin film by carrying out lamp heating just for a few seconds. As such, the film formation process is easy, time-efficient, and economically efficient.

According to the production method of a magnetic recording medium of the second aspect of the present invention, it is possible to produce a magnetic recording medium comprising an L1₀FePt thin film within a short time by a low-temperature process. In addition, a polycrystalline material such as glass can be used as a substrate; and accordingly, an ordinarily employed aluminum substrate or glass substrate can be used. Therefore, it is not necessary to carry out a high-temperature process such as epitaxial growth or a special process for forming a film such as a buffer layer. Further, in adding ZnO etc., it can be used as a target to form a film by sputtering. Therefore, the production method of the present invention is technically easy and economically highly efficient. Furthermore, an L1₀FePt thin film which is highly (001)-oriented and highly L1₀-ordered can be obtained within a short time by rapid annealing. Therefore, it can be easily put to practical use and is economically efficient. In a case the shortest annealing time, it is possible to obtain an L1₀FePt thin film by carrying out lamp heating just for a few seconds. As such, the film formation process is easy, time-efficient, and economically efficient.

### BRIEF DESCRIPTION OF THE DRAWINGS

FIG. 1 is a flowchart showing one example of a production method of a magnetic recording medium of the present invention.

FIG. 2A is a view schematically showing one example of a cross section of the magnetic recording medium of the present invention halfway through the production thereof.

FIG. 2B is a view schematically showing one example of an annealing step S2.

FIG. 3A is a graph showing the results of a structural analysis conducted by an X-ray analyzer on samples whose annealing temperature was 400° C.

FIG. 3B is a graph showing the results of a structural analysis conducted by an X-ray analyzer on samples whose annealing temperature was 500° C.

FIG. 4 is a graph showing dependency of peak intensity on the amount of ZnO added, based on the analysis results obtained by the X-ray analyzer.

FIG. 5A is a graph showing the results of magnetization measurement conducted by a vibrating sample magnetometer on samples whose annealing temperature was 400° C.

FIG. 5B is a a graph showing the results of magnetization measurement conducted by a vibrating sample magnetometer on samples whose annealing temperature was 500° C.

FIG. 6 is a schematic view of an L1₀-ordered structure, taking an L1₀FePt alloy as an example.

### MODE FOR CARRYING OUT THE INVENTION

The inventors have found that an L1₀FePt thin film which is highly (001)-oriented and highly L1₀-ordered can be obtained by adding a specific metal oxide to an FePt alloy and performing rapid annealing thereof. A film of the FePt alloy formed by sputtering at room temperature is a collection of fcc fine crystals. Annealing this FePt film to several hundred Celsius causes recrystallization of the film and grain growth. The fcc phase is a metastable phase, and the L1₀ phase is a thermal equilibrium phase; therefore when atomic diffusion takes place sufficiently, the film transforms from the fcc phase into the L1₀ phase in this recrystallization process. Further, when a tensile stress acts between the fine crystal grains in the film's in-plane direction in the recrystallization process, the L1₀ phase formed to ease the strain becomes (001)-oriented in the direction perpendicular to the film plane. This tensile stress is eased gradually as time passes; however, if the recrystallization process is promoted by the rapid annealing before the tensile stress is eased, it is possible to form an L1₀FePt thin film which is highly (001)-oriented and highly L1₀-ordered.

When a metal oxide is sputtered to form a film, the metal atom, the oxygen atom, and the oxide molecule dissociated by sputtering ejected onto the substrate. At this time, if the metal oxide and an FePt alloy are sputtered simultaneously to form a film with the substrate at room temperature, the thin film formed becomes a mixture of the metal atom, oxygen atom, oxide molecule, and FePt alloy. Annealing this thin film causes the metal atom to move in the FePt alloy, which is a parent phase, and recombine with the oxygen atom to form an oxide. If the diffusion coefficient of the metal atom added at the time sputtering is large enough at low temperature, the metal atom can easily move in the FePt alloy even at low temperature. Therefore, the recrystallization process can be induced at low temperature. Further, the oxide formed as a result of the recombination of the atoms promotes formation of a highly (001)-oriented film by controlling the crystal growth process of the thin film occurring during annealing. However, if the oxide formation free energy of the metal atom added is higher than that of Fe, an Fe oxide will be formed and the metal atom added will dissolve in L1₀FePt to form a solid solution or precipitate in L1₀FePt at the grain boundary. As a result, properties of the L1₀FePt will degrade. In addition, if the oxide formation free energy is low and the stability of the oxide is too high, dissociation of the metal atom at the time of sputtering does not take place sufficiently, preventing facilitation of diffusion thereof. From such viewpoints, the inventors have invented a method of obtaining an L1₀FePt thin film which is highly (001) -oriented and highly L1₀-ordered by specifying a metal oxide to be added to an FePt alloy, as described below.

An embodiment of the present invention will be described hereinafter. It should be noted that the present embodiment is just one mode for carrying out the present invention. Therefore, the present invention is not limited to the present embodiment, and can have modified embodiments within a range that does not depart from the gist of the present invention.

<Production Method of a Magnetic Recording Medium>

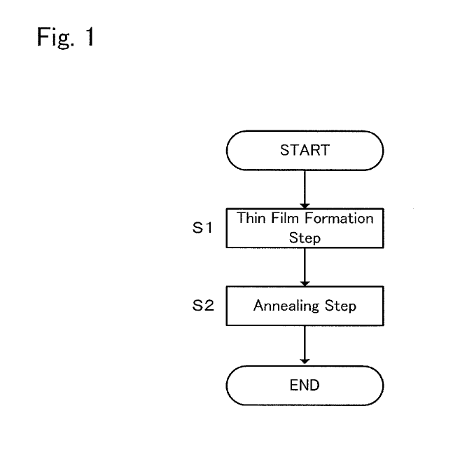

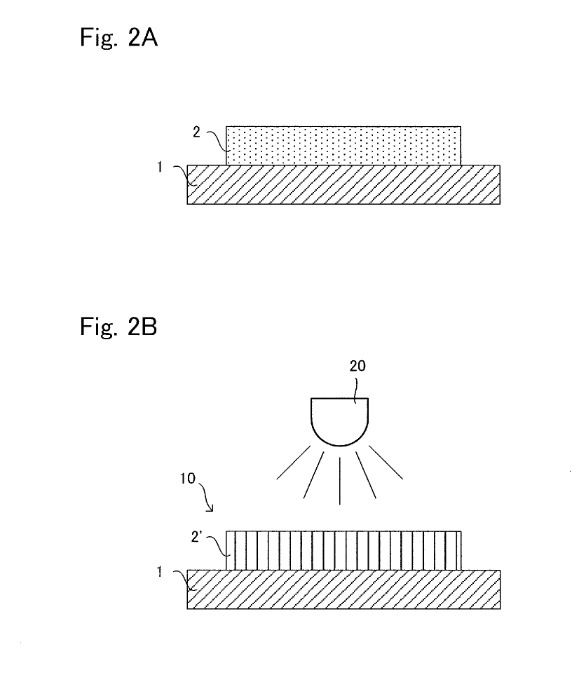

FIG. 1 shows a flowchart of a production method of a magnetic recording medium of the present invention, as one example. In addition, FIG. 2A schematically shows one example of a cross section of the magnetic recording medium of the present invention halfway through the production thereof. FIG. 25 schematically shows one example of an annealing step S2.

As shown in FIG. 1, the production method of a magnetic recording medium of the present invention comprises a thin film formation step S1 and an annealing step S2. Through these steps, it is possible to produce, at low temperature, a magnetic recording medium comprising an L1₀FePt film which is highly (001)-oriented and highly L1₀-ordered. Each of the steps will be explained below.

(Thin Film Formation Step S1)

The step S1 is a step of forming, on a substrate 1, a thin film 2 which contains an FePt alloy and an oxide of predetermined metal described below (see FIG. 2A). The substrate 1 that can be employed in the present invention is not particularly limited as long as it can be used to produce a magnetic recording medium. For example, a substrate made of metal or of glass may be employed as the substrate 1. However, in order to produce a practical magnetic recording medium, it is preferable to layer a soft magnetic layer (such as a material with low coercivity and Co-based amorphous) in a lower part of the thin film 2.

If the content ratio of Fe and Pt in the thin film 2 obtained in the step Si is outside the ratio Fe:Pt=1:1 at mole ratio, the L1₀ ordering of an FePt alloy obtained after the following annealing step S2 will degrade. Therefore, the content ratio of Fe and Pt in the thin film obtained in the step S1 is preferably around Fe:Pt=45-55:55-45 at mole ratio.

The method of forming, on the substrate 1, the thin film 2 which contains the FePt alloy and the oxide of predetermined metal is not particularly limited. For example, Fe, Pt, and an oxide of predetermined metal each may be used as a target to form a film by simultaneous sputtering. An FePt alloy may also be used as a target instead of Fe and Pt, to form a film by sputtering. Further, an oxide of predetermined metal may be mixed in an FePt alloy to make a mixture in advance, which is then used as a target to form a film by sputtering. In the case of forming a film by sputtering using an FePt alloy as a target, the composition ratio of FePt can be easily fixed.

The predetermined metal to constitute a metal oxide that can be employed in the present invention is metal having a melting point of 100° C. or more and 500° C. or less. The reason is that when considering practical use of a magnetic recording medium, it is desirable to facilitate L1₀ ordering and attain high (001) orientation at a low temperature of about 100° C. or more and 500° C. or less. A diffusion coefficient of an alloy is determined by the total of the diffusion coefficients of the elements constituting the alloy, but the element having the largest diffusion coefficient controls the diffusion process. The diffusion coefficient of a metal element can be roughly estimated from the melting point thereof. The melting point of Fe and Pt is 1500° C. or more, and the diffusion coefficient thereof at near room temperature is low. Therefore, in order to induce diffusion thereof at a temperature of around 100° C. or more and 500° C. or less, it is necessary to add a substance that has a melting point of 100° C. or more and 500° C. or less. Examples of such metal elements include Li, Zn, Se, Sn, In, and Bi.

Further, the predetermined metal to constitute the metal oxide employed in the present invention preferably has an oxide formation free energy ΔG_{f}° of −800 kJ/mol or more and −500 kj/mol or less at room temperature. If the oxide formation free energy of the metal added is higher than that of Fe, an Fe oxide will be formed and the metal added will dissolve in L1₀FePt to form a solid solution or precipitate in L1₀FePt at the grain boundary. Therefore, the properties of L1₀FePt may not be exhibited. On the other hand, if the oxide formation free energy of the metal added is too low and the stability of the oxide is too high, dissociation of the metal atom during sputtering will not take place sufficiently, preventing facilitation of diffusion thereof.

Examples of the oxide of metal that meets the melting point range and the oxide formation free energy range described above include ZnO, SnO₂, In₂O₃, Na₂O. Among these oxides, ZnO is preferred as it is easy to use and safe.

In the case of employing the FePt alloy and ZnO as the material to constitute the thin film 2, the content of ZnO to the total amount of the FePt alloy and ZnO, is preferably 2.5 volume % or more and 20 volume % or less. If the proportion of ZnO in the material constituting the thin film 2 is too small or if it is too large, the (001) orientation of an L1₀FePt alloy obtained after the following annealing step S2 is likely to degrade and the magnetic anisotropy thereof is likely to deteriorate.

<Annealing Step S2>

The step S2 is a step of heating the thin film 2 that has been obtained in the step Si to a predetermined temperature. Through the step S2, the thin film 2 can become a magnetic recording layer 2′ (see FIG. 2B).

In the step S2, the annealing rate at which to anneal the thin film 2 to a predetermined temperature is preferably 30° C./s or more, and more preferably 50° C./s or more. Increasing the annealing rate enables the L1₀FePt alloy to be highly (001)-oriented and highly L1₀-ordered, leading to improvement of magnetic anisotropy.

The annealing method in the step S2 is not particularly limited. An example may be carrying out infrared heating by an infrared irradiation apparatus 20 as shown in FIG. 2B.

It should be noted that the “predetermined temperature” given in the step S2 is preferably 400° C. or more and 500° C. or less. If this temperature is too low, the (001) orientation of L1₀FePt is likely to degrade; and if it is too high, it is unfavorable in view of productivity.

<Other Step>

The production method of a magnetic recording medium of the present invention comprises at least the step S1 and the step S2 described above. It may further comprise the step of forming a thin protective layer on the magnetic recording layer 2′ after the step S2. This protective layer may be constituted by DLC (diamond-like carbon). The method of forming a protective film is not particularly limited. Methods such as a plasma vapor deposition may be employed to form a protective film.

As has been described so far, according to the production method of a magnetic recording medium of the present invention, it is possible to produce a magnetic recording medium comprising an L1ₒFePt thin film within a short time by a low-temperature process. In addition, a polycrystalline material such as glass can be used as a substrate; and accordingly, an ordinarily employed aluminum substrate or glass substrate can be used. Therefore, it is not necessary to carry out a high-temperature process for epitaxial growth etc., or a special process for forming a film such as a buffer layer. Further, in adding ZnO, it can be used as a target to form a film by sputtering. Therefore, the production method of the present invention is technically easy and economically highly efficient. Furthermore, an L1₀FePt thin film which is highly (001)-oriented and highly L1₀-ordered can be obtained by short-time rapid annealing with a short holding time. Therefore, it can be easily put to practical use and is economically efficient. Especially, it is possible to obtain an L1₀FePt thin film by carrying out lamp heating just for a few seconds at shortest. As such, the film formation process is easy, time-efficient and economically efficient.

<Magnetic Recording Medium>

The magnetic recording medium of the present invention can be obtained by the production method of a magnetic recording medium of the present invention. That is, the magnetic recording medium of the present invention comprises a magnetic recording layer which contains an FePt alloy having an L1₀-ordered structure and an oxide of metal having a melting point of 100° C. or more and 500° C. or less. The oxide formation free energy ΔG_{f}° at room temperature, of the metal is preferably −800 kJ/mol or more and −500 kJ/mol or less. ZnO is especially preferred as such a metal oxide. Further, in the case of containing ZnO in the magnetic recording layer, the content of ZnO to the total amount of the L1₀FePt alloy and ZnO is preferably 2.5 volume % or more and 20% volume or less.

### EXAMPLES

Hereinafter, the present invention will be described in more detail in Example, to which however the present invention is not limited. It should be noted that the “%” given herein refers to volume % of the whole magnetic recording layer (thin film), unless stated otherwise.

<Production Method of Samples>

More than one sample was made through the procedures described below. First, using each of Fe, Pt, and ZnO (all made by Furuuchi Chemical Corporation) as a target, a thin film in which a predetermined amount of ZnO was added in an FePt alloy was formed on a substrate of a thermally oxidized Si (a surface of a Si substrate is coated with an oxidized film made of SiO₂) by using a sputtering apparatus for forming an alloy film (Ar gas pressure: 0.5 Pa). The film thicknesses of the obtained thin films differed from one another based on the amount of ZnO added and were “6.9 nm+the amount of ZnO added”. That is, the film thickness of the thin film was arranged to be 6.9×(1+x) nm (x being the ratio of ZnO to the FePt alloy in the whole thin film). After forming the films, they were annealed to a predetermined temperature (hereinafter referred to as an “annealing temperature”) at a rate of 56° C/s in vacuum atmosphere (2.0×10⁻⁴ Pa), by using an infrared rapid heating apparatus (VHC-P45C-S, manufactured by ULVAC-RIKO, Inc.); and were held for 10 minutes at this annealing temperature.

<Evaluation Method>

The samples made by the above procedures were subjected to: structural analysis using an X-ray analyzer (JDX-3530 hereinafter referred to as “XRD”, manufactured by JEOL Ltd.); magnetization measurement using a vibrating sample magnetometer (VSM5ₛ-type-15 hereinafter referred to as “VSM”, manufactured by Toei Scientific Industrial Co., Ltd.); and surface contour observation using a scanning probe microscope (E-Sweep hereinafter referred to as “SPM”, manufactured by SII NanoTechnologyInc.).

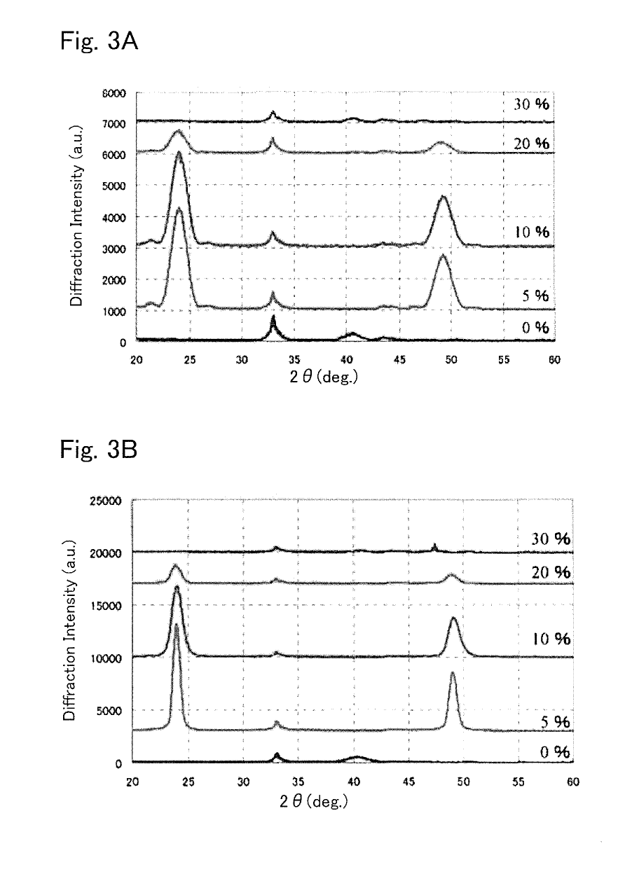

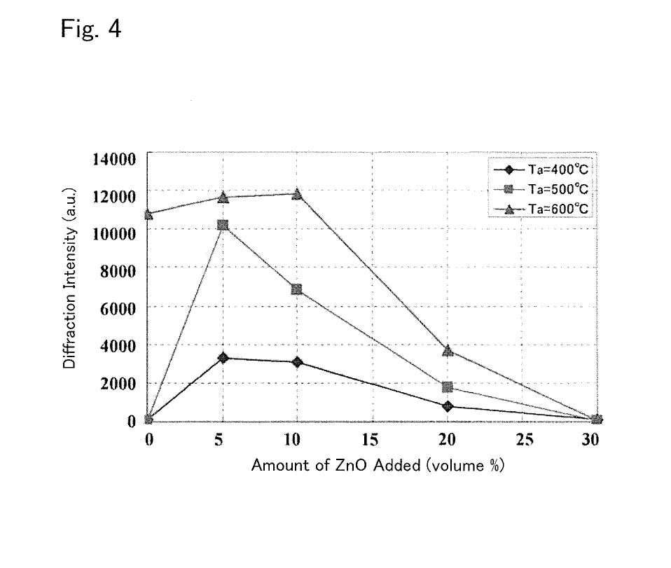

Made by the above procedures were the samples in which the amount of ZnO added was 0%, 5%, 10%, 15%, 20%, 25%, and 30% and in which the annealing temperature was 400° C., 500° C., and 600° C. The results of the structural analysis conducted using XRD are shown in Fig.3. FIG. 3 is a graph with a diffraction angle 2θ in the horizontal axis and a diffraction intensity in the vertical axis; and shows the analysis results by XRD of the samples in which the amount of ZnO added was 0%, 5%, 10%, 20%, and 30%. FIG. 32A shows the case in which the annealing temperature was 400° C. FIG. 3B shows the case in which the annealing temperature was 500° C. FIG. 4 is a graph showing dependency of peak intensity on the amount of ZnO added. With the amount of ZnO added in the horizontal axis and the diffraction intensity of the (001) plane in the vertical axis, FIG. 4 shows the dependency of the diffraction intensity of the (001) surface on the amount of ZnO added, with respect to the samples whose annealing temperature was 400° C., 500° C., and 600° C.

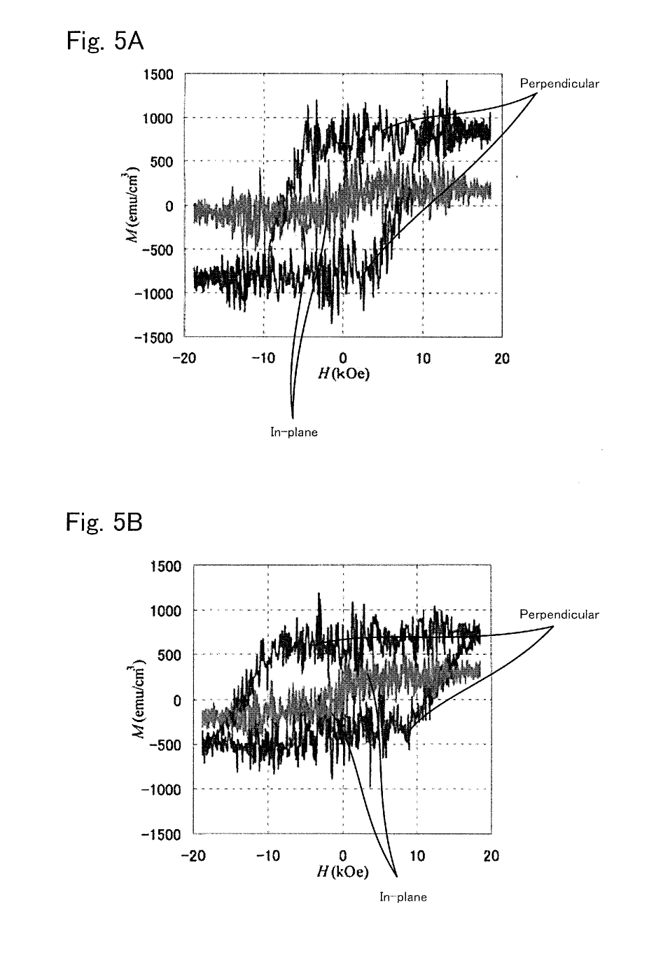

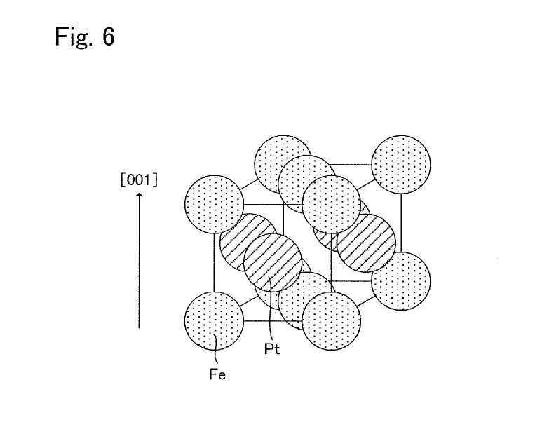

In addition, FIG. 5 shows the results of the magnetization measurement conducted on the same samples by VSM. Only the measurement results of the sample in which the amount of ZnO added was 5% are shown in FIG. 5. The horizontal axis of FIG. 5 represents a magnetic field H (kOe), and the vertical axis thereof represents a value M of magnetization (emu/cm³). FIG. 5A shows the case when the annealing temperature was 400° C. and FIG. 5B is the case when the annealing temperature was 500° C.

The following can be understood from the results shown in FIGS. 3 and 4. As for the diffraction intensity on the (001) plane, especially when the amount of ZnO is around 5% to 10%, an L1₀FePt film which is highly (001)-oriented and highly L1₀-ordered can be obtained. Further, when the annealing temperature was 400° C., a satellite peak was observed in the (001) diffraction line, and the smoothness was high. The L1₀ ordering of the sample with the ZnO content at 5% and of the sample with the ZnO content at 10% was about 98% when calculated by fitting, using the total diffraction lines. Further, when looking at the magnetization curves in FIG. 5, a clear difference can be seen in the magnetization curves between the in-plane direction and the perpendicular direction, showing there is high magnetic anisotropy. In addition, when the annealing temperature was 400° C., it can be seen that there is high coercivity of 8 kOe or more, and that high coercivity can be attained if the film is patterned by refining.

In addition, observing the surface contour by SPM, it was found that the surface roughness Ra of the sample in which the amount of ZnO added was 5% and the annealing temperature was 400° C., was 0.31 nm; and that the surface roughness Ra of the sample in which the amount of ZnO added was 10% and the annealing temperature was 400° C., was 0.30 nm. That is, both samples had a favorable surface condition.

The present invention has been described above as to the embodiment which is supposed to be practical as well as preferable at present. However, it should be understood that the present invention is not limited to the embodiment disclosed in the specification of the present application and can be appropriately modified within the range that does not depart from the gist or spirit of the invention, which can be read from the appended claims and the overall specification, and a magnetic recording medium and a production method of a magnetic recording medium with such modifications are also encompassed within the technical range of the invention.

### DESCRIPTION OF THE NUMERALS

1 substrate
2 thin film
2′ magnetic recording layer
10 magnetic recording medium

1. A magnetic recording medium comprising a magnetic recording layer which contains an FePt alloy having an L1₀-ordered structure and an oxide of metal having a melting point of 100° C. or more and 500° C. or less.

2. The magnetic recording medium according to claim 1, wherein an oxide formation free energy ΔG_{f}° at room temperature, of said metal is −800 kJ/mol or more and −500 kJ/mol or less.

3. The magnetic recording medium according to claim 1 or 2, wherein said oxide of metal is ZnO.

4. The magnetic recording medium according to claim 3, wherein said ZnO is contained in said magnetic recording layer in an amount of 2.5 volume % or more and 20 volume % or less with respect to the total amount of said FePt alloy and said ZnO.

5. A production method of a magnetic recording medium, wherein a thin film formation step of forming a thin film containing an FePt alloy and an oxide of metal having a melting point of 100° C. or more and 500° C. or less is carried out, and an annealing step of annealing said thin film to a predetermined temperature is carried out, to thereby form a magnetic recording layer containing said FePt alloy having an L1₀-ordered structure and said oxide of metal.

6. The production method of a magnetic recording medium according to claim 5, wherein an oxide formation free energy ΔG_{f}° at room temperature, of said metal is −800 kJ/mol or more and −500 kJ/mol or less.

7. The production method of a magnetic recording medium according to claim 5, wherein said oxide of metal is ZnO.

8. The production method of a magnetic recording medium according to claim 7, wherein said ZnO is contained in said magnetic recording layer in an amount of 2.5 volume % or more and 20 volume % or less with respect to the total amount of said FePt alloy and said ZnO.

9. The production method of a magnetic recording medium according to claim 5, wherein said annealing step is a step of annealing said thin film to a predetermined temperature at an annealing rate of 30° C. or more per second.

10. The production method of a magnetic recording medium according to claim 5, wherein said annealing step is a step of annealing said thin film to a temperature of 400° C. or more and 500° C. or less.
